(19) United States
(12) Patent Application Publication
(10) Pub. No.: US 2010/0262864 A1
(43) Pub. Date: Oct. 14, 2010

(54) AUTOMATIC REPRODUCTION TEST DEVICE AND AUTOMATIC REPRODUCTION TEST METHOD IN EMBEDDED SYSTEM

(76) Inventors: Yoshinori Tsujido, Tokyo (JP); Norihiro Naito, Tokyo (JP)

Correspondence Address: BIRCH STEWART KOLASCH & BIRCH, PO BOX 747, FALLS CHURCH, VA, 22040-0747, US

(21) Appl. No.: 12/747,150

(22) PCT Filed: Oct. 29, 2008
(86) PCT No.: PCT/JP2008/003096

§ 371 Date: Jun. 9, 2010

(30) Foreign Application Priority Data
Feb. 26, 2008 (JP) 2008-044553

(51) Int. Cl. G06F 11/28

(52) U.S. Cl. 714/32; 714/E11.178

(57) ABSTRACT

An automatic reproduction test device in an embedded system to which external equipment (10) is connected. It includes a history storage unit (information storage 20) for storing operation events of the embedded system and events including state variations of the external equipment in a time series, and a reproduction test unit (reproduction test device 2) for reading out contents stored in the history storage unit in response to a reproduction instruction from outside, for reproducing an internal state of the embedded system in accordance with the contents read out, and for carrying out a reproduction test of the embedded system a prescribed number of times repeatedly.

### TECHNICAL FIELD

The present invention relates to an automatic reproduction test device and an automatic reproduction test method in an embedded system that is used as a generic name of electronic devices into which processors are embedded to achieve particular functions.

### BACKGROUND ART

In an embedded system such as onboard information equipment, a centralized control device, which has a display monitor and a control panel (touch panel, for example) like buttons and a dial can achieve a lot of functions such as car navigation functions, AV (Audio Visual) functions, telephone functions, control of various functional components of a vehicle like an air conditioner, doors and engine, and state display functions.

These functions, which are achieved by software using one to several processors (CPUs), are efficiently executed by an operating system and the like achievable without any interference between functions on each processor.

However, because of sharing limited resources (such as a display unit and a voice output unit), not all the functions are achieved fully independently, but the individual functions are achieved practically while carrying out mutual communication between them. Accordingly, in the field of the embedded systems, software systems for realizing complicated systems at high reliability and development of software for executing a test efficiently to ensure the reliability have become the most important design matters.

As for the test of the conventional embedded system such as the onboard information equipment, however, a variety of operations are basically performed manually using a benchmark test, which has dedicated devices connected for simulating various peripheral functions of a vehicle or the like, to confirm that no inconvenience or problems exist.

On the other hand, as for the test method in the embedded system described above, many patent applications are filed conventionally. For example, a karaoke device is known which stores an operation history of a user and tries to improve the efficiency of the test by reproducing the operations equivalent to the history (see Patent Document 1, for example).

Patent Document 1: Japanese Patent Laid-Open No. 2000-47911.

As described above, as for the test in the conventional embedded system such as onboard information equipment, it is executed using the manual operation or the method such as reproducing the operations according to the operation history.

However, in the complicated embedded system such as onboard information equipment, the reproduction test based on only the operation history is not enough as test contents. This is because its behavior tremendously varies depending on various parts such as doors, engine, wheels and transmission, and on external equipment such as an air conditioner, which are connected to the outside of the centralized control device. For example, in a driving state in which wheels are rotating, operations of the car navigation functions must be restricted or altered to ensure the safety of the driver. In addition, if an ECU (electronic control unit) detects a disorder of the engine or the like, changes in the conditions of the external equipment have great influence on the behavior of the system such as displaying that state on the monitor.

In addition, the external equipment and the centralized control device operate asynchronously in general. For example, as for the internal state of the centralized control device, since the navigation functions and AV functions operate asynchronously and independently, reproducing only the operation history cannot always repeat the same behavior. Furthermore, as for unexpected voltage fluctuations, a single reproduction test cannot always repeat them. Thus, the conventional system has a problem in the reliability of the fault analysis or of the reproduction test performed at a fault, which impairs the efficiency.

The present invention is implemented to solve the foregoing problems. Therefore it is an object of the present invention to provide an automatic reproduction test device in an embedded system, which can improve the reproducibility to ensure the reliability of the complicated embedded system, and can achieve an efficient reproduction test.

### DISCLOSURE OF THE INVENTION

To solve the foregoing problems, an automatic reproduction test device in an embedded system in accordance with the present invention is an automatic reproduction test device in an embedded system to which external equipment is connected, the automatic reproduction test device comprising: a storage unit for storing operation events of the embedded system and events including state variations of the external equipment in a time series as an operation history; and a history reproduction unit for reading out the operation history stored in the storage unit in response to a reproduction instruction from outside, for reproducing a system state of the embedded system in accordance with the operation history read out, and for carrying out a reproduction test of the embedded system a prescribed number of times repeatedly.

In addition, an automatic reproduction test method in an embedded system in accordance with the present invention is an automatic reproduction test method of an embedded system which is used for an automatic reproduction test device having at least a history storage unit, and has external equipment connected, the automatic reproduction test method comprising: a step of storing operation events of the embedded system and events including state variations of the external equipment in a time series; and a step of reading out contents stored in the history storage unit in response to a reproduction instruction from outside, of reproducing a system state of the embedded system in accordance with the contents read out, and carrying out a reproduction test of the embedded system a prescribed number of times repeatedly.

According to the present invention, it can provide an automatic reproduction test device and automatic reproduction test method in an embedded system, which can improve the reproducibility for ensuring the reliability of the complicated embedded system and can enable efficient reproduction test.

### BRIEF DESCRIPTION OF THE DRAWINGS

FIG. 1 is a block diagram showing an internal configuration of an automatic reproduction test device in an embedded system of an, embodiment 1 in accordance with the present invention;

FIG. 2 is a block diagram showing an internal configuration of a reproduction test device of the automatic reproduction test device in the embedded system of the embodiment 1 in accordance with the present invention with its functions developed;

FIG. 3 is a flowchart showing the operation of the automatic reproduction test device in the embedded system of the embodiment 1 in accordance with the present invention;

FIG. 4 is a block diagram showing an internal configuration of an automatic reproduction test device in an embedded system of an embodiment 2 in accordance with the present invention;

FIG. 5 is a block diagram showing an internal configuration of the reproduction test device of the automatic reproduction test device in the embedded system of the embodiment 2 in accordance with the present invention with its functions developed; and

FIG. 6 is a flowchart showing the operation of the automatic reproduction test device in the embedded system of the embodiment 2 in accordance with the present invention.

### BEST MODE FOR CARRYING OUT THE INVENTION

The best mode for carrying out the invention will now be described with reference to the accompanying drawings to explain the present invention in more detail.

### Embodiment 1

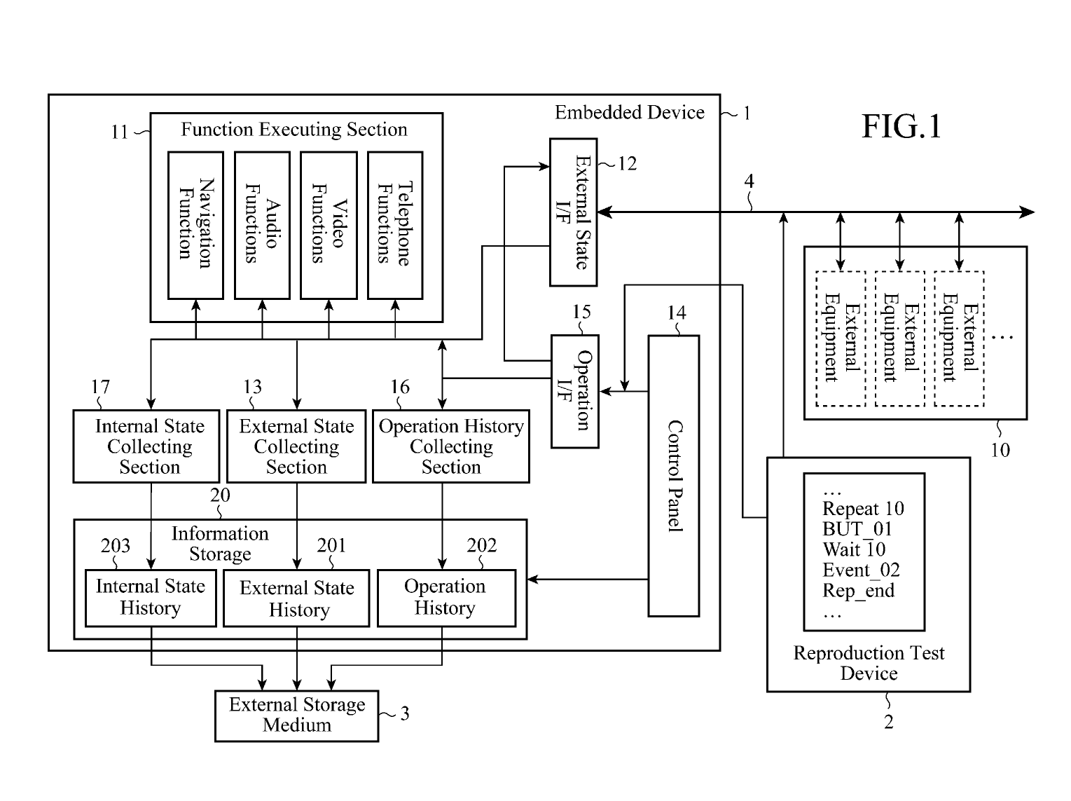

FIG. 1 is a block diagram showing an internal configuration of an automatic reproduction test device in an embedded system of an embodiment 1 in accordance with the present invention.

As shown in FIG. 1, the automatic reproduction test device in the embedded system of the embodiment 1 in accordance with the present invention comprises an embedded device 1, a reproduction test device 2 and an external storage medium 3. Here, onboard information equipment is shown as an example of the embedded device 1.

The onboard information equipment 1 has a function executing section 11 for carrying out navigation functions, audio functions, video functions, telephone functions and other various functions, and is connected to external equipment 10 via an external state I/F (interface) 12. The external equipment 10 is assume to be an ECU (electronic control unit) to which various vehicle parts such as doors, engine, wheels, transmission, and vehicle speed sensor are connected. For example, they are connected to the external state I/F 12 via a serial communication line like a CAN (Control Area Network) bus 4.

The state information on the external equipment 10 acquired by communication via the external state I/F 12 is collected by an external state collecting section 13, which stores it in an information storage 20 together with time information as an external state history 201. In addition, a control panel 14 is connected to an operation history collecting section 16 via an operation I/F 15. Operation commands generated by a user operating the control panel 14 are collected by the operation history collecting section 16, which stores them in the information storage 20 together with the time information as an operation history 202.

In addition, the function executing section 11 is connected to an internal state collecting section 17. The internal states such as internal register values, which vary in accordance with the execution of the various functions by the function executing section 11, are stored in the information storage 20 as an internal state history 203 in a time series fashion in association with the foregoing external state history 201 and the operation history 202.

Incidentally, the information storage 20 is composed of a ring buffer or RAM, and when the onboard information equipment 1 is working, it stores in addition to the operation history 202 the external state history 201 and internal state history 203. When a prescribed volume of data is stored by the user operation via the control panel 14, they are automatically copied to the external storage medium 3 composed of a removable memory card or HD (Hard Disk).

On the other hand, the reproduction test device 2 is composed of a PC (Personal Computer), for example. By installing the external storage medium 3 in a memory slot in the device, the PC reads logs such as the external state history 201, internal state history 203, and operation history 202 which are stored in the external storage medium 3, generates information simulating the logs to restore the system state of the onboard information equipment 1 on the PC, and carries out a reproduction test by simulating the operation.

Accordingly, the information storage 20 of the onboard information equipment 1 functions as a “history storage unit for storing operation events of the embedded system and events including state variations of the external equipment in a time series” of claim 1, and the reproduction test device 2 functions as a “reproduction test unit for reading out contents stored in the history storage unit in response to a reproduction instruction from outside, for reproducing a system state of the embedded system in accordance with the contents read out, and for carrying out a reproduction test of the embedded system repeatedly a prescribed number of times” of claim 1. The details will be described later.

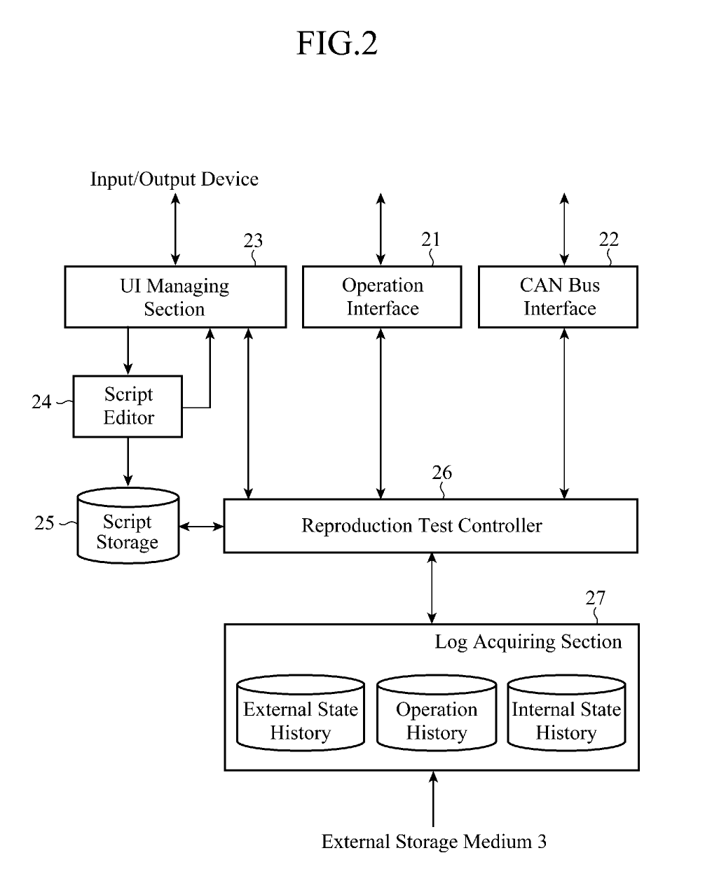

FIG. 2 is a block diagram showing an internal configuration of the reproduction test device 2 shown in FIG. 1 with its functions developed. As shown in FIG. 2, the reproduction test device 2 comprises an operation interface 21, a CAN bus interface 22, a UI (User Interface) managing section 23, a script editor 24, a script storage 25, a reproduction test controller 26, and a log acquiring section 27.

The operation interface 21 manages the interface with the control panel 14 of the onboard information equipment 1, and the CAN bus interface manages the interface with the individual vehicle parts to carry out communication between the onboard information equipment 1 and reproduction test device 2.

The UI managing section 23 manages the user interface with the input/output device (here it is assumed to be a keyboard and a display device) connected to the reproduction test device 2. It acquires the operation input to the keyboard by the user and outputs to the script editor 24 to display a script editing result by the script editor 24. In addition, it acquires a user instruction relating to a start of the reproduction test controller 26 and the like, delivers to the reproduction test controller 26, and displays a result of a reproduction test by the reproduction test controller 26.

According to the user instruction arriving via the UI managing section 23, the script editor 24 edits a reproduction test procedure stored in the script storage 25 in advance, and alters the reproduction procedure or parameters stored in the script storage 25. Here, as parameters are supposed an interval time period of the repeated reproduction tests, time intervals of events associated with operation button presses and external state variations. Incidentally, as for the parameters, values set by default can be used without editing.

According to the reproduction instruction arriving via the UI managing section 23, the reproduction test controller 26 reproduces the system state of the onboard information equipment 1 from the various logs (external state history 201, operation history 202 and internal state history 203) acquired from the onboard information equipment 1, and carries out the reproduction tests of the onboard information equipment 1 a prescribed number of times repeatedly in accordance with the procedure of the reproduction test stored in the script storage 25.

The reproduction test controller 26, taking the opportunity of the reproduction of a particular event such as an occurrence of a fault, can instruct the onboard information equipment 1 to perform reacquisition instruction of the information about the state variations just before via the CAN bus interface 22. The reproduction test controller 26 can also convert the procedure that defines the procedure of the reproduction test into text to retain it (script converter), followed by executing the reproduction test after the editing carried out by the script editor 24.

Incidentally, the log acquiring section 27 acquires the logs such as the external state history 201, operation history 202 and internal state history 203 from the external storage medium 3 such as a memory card inserted to a slot not shown at the automatic reproduction test, and supplies the logs to the reproduction test controller 26.

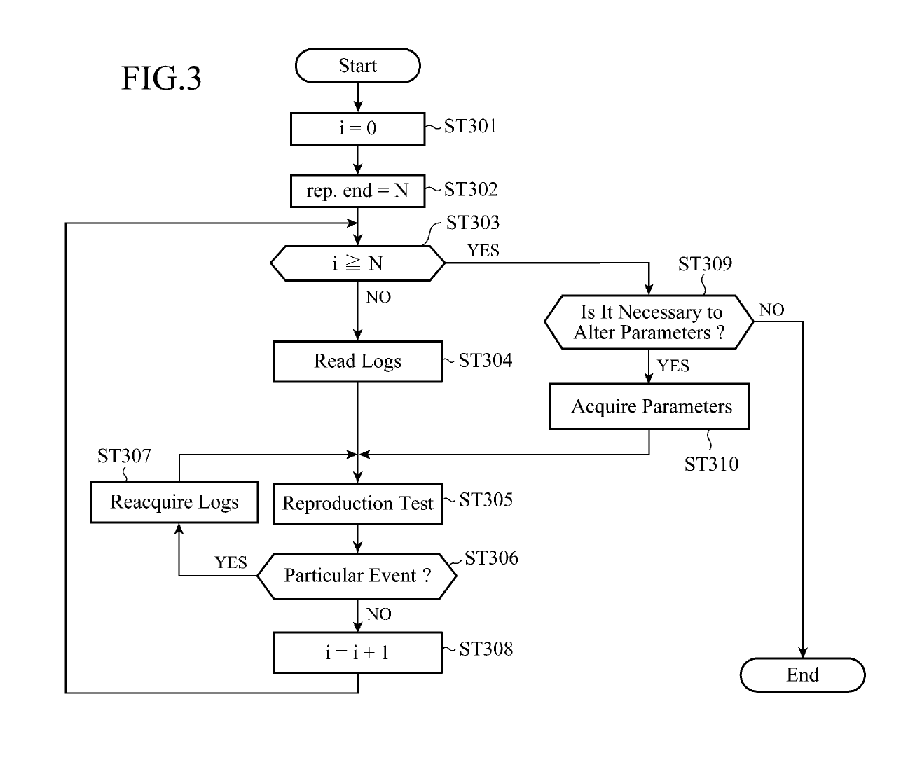

FIG. 3 is a flowchart showing the operation of the automatic reproduction test device in the embedded system of the embodiment 1 in accordance with the present invention.

Referring to the flowchart of FIG. 3, the operation of the reproduction test device 2 in the embedded system of the embodiment 1 in accordance with the present invention shown in FIG. 1 and FIG. 2 will be described in detail below.

The onboard information equipment 1 acquires, at fixed intervals during the operation of the system, various logs consisting of the external state history 201, operation history 202 and internal state history 203 via the external state collecting section 13, operation history collecting section 16 and internal state collecting section 17, and stores them in the information storage 20. Here, in response to the user operation or at the timing when the prescribed volume is stored, the logs are copied to the external storage medium 3 such as a memory card.

The copied logs (memory card) are inserted into the card slot of the reproduction test device 2 consisting of a PC or the like. Then the reproduction test shown by the flowchart of FIG. 3 is started after waiting for the reproduction test start operation (reproduction instruction) of the user via the input/output device not shown, which is connected to the reproduction test device 2.

In the flowchart of FIG. 3, detecting the reproduction test start operation (reproduction instruction) by the user via the UI managing section 23, the reproduction test controller 26 sets zero to a variable i (register i) (step ST301), followed by setting the number of times N of the repeated reproduction tests to the variable rep.end (step ST302). Incidentally, the variable i and rep.end are assumed to be registers used by the program, here. Subsequently, the reproduction test controller 26 makes a decision as to whether the variable i reaches the number of times N of the repeated reproduction tests or not (step ST303). Unless it reaches (“NO” at step ST303), it reads the various logs stored in the external storage medium 3 via the log acquiring section 27 (step ST304) and starts the reproduction test (step ST305).

The procedure of the reproduction test is assumed to follow the test script stored in the script storage 25, and the reproduction test controller 26 carries out the test while reproducing the system state of the onboard information equipment 1 from the various logs read out previously and in accordance with the command defined in each line of the test script and the repeated period and the number of times of repetition.

Characteristically, since the state variations of the external equipment 10 and events are acquired together with the time information as the logs in addition to the operation history, the reproduction test controller 26 is characterized by being able to reflect the state variations of the external equipment 10 and events in the restoration of the system state of the onboard information equipment 1 while synchronizing with the operation history, and to carryout the repeated reproduction tests based on the logs.

If a particular event such as a fault is detected during the foregoing reproduction test (“YES” at step ST306), the reproduction test controller 26 instructs the onboard information equipment 1 having the external equipment 10 to carry out the reacquisition instruction of detailed logs about the state variations just before via the CAN bus interface 22 and CAN bus 4 (step ST307).

According to the detailed logs reacquired here, the reproduction test is carried out again (step ST305), which makes it possible to analyze, if the same event occurs again, the same problem in more detail, and to store the detailed logs collected.

When the reproduction test has been completed once as described above, the reproduction test controller 26 updates the variable i by adding +1 thereto (step ST308), and carries out reading of the logs and the reproduction test from step ST303 forward repeatedly (step ST303-ST308). The repeated reproduction tests are performed the number of times N repeatedly set at the variable rep.end.

In this way, the present embodiment is configured in such a manner that it can carry out the reproduction tests while restoring the system state repeatedly for the event that will not appear in only a single reproduction trial such as voltage fluctuations. Thus, it can perform accurate, high-degree reproduction tests.

Incidentally, when the N-times reproduction tests have been completed (“YES” at step ST303), the reproduction test controller 26 displays a message so stating on the input/output device via the UI managing section 23, and prompts the user to express his or her decision by displaying a message asking whether it is necessary to change the parameters or not.

The foregoing reproduction tests are carried out a fixed number of times at fixed repeated intervals. The reproduction test controller 26 acquires altered parameters (step ST310) which are input when the user makes a decision that the parameters must be altered (“YES” at step ST309), and edits the script via the script editor 24. Thus, it updates the script stored in the script storage 25. Then, the reproduction test controller 26 carries out the foregoing repeated reproduction tests again in accordance with the script that has been updated and stored by the script storage 25.

As described above, the present embodiment gives reproduction guidance by carrying out time adjustment between the individual events or by varying the repeated intervals in a very small range, which makes it possible to achieve highly accurate reproduction by the repeated tests.

According to the automatic reproduction test device in the embedded system of the embodiment 1 in accordance with the present invention, since it stores the state variations of the external equipment 10 and the events as the logs in addition to the operation history, and enables reproduction of the state variations of the external equipment 10 and events in synchronization with the operation history, it can achieve highly accurate reproduction test in which the state variations do not depend only on the user operation.

In addition, as for an event that will not appear in only a single reproduction test (such cases will occur frequently in the latter half of a developing phase), the present embodiment carries out the reproduction tests while restoring the repeated state, and this enables the highly accurate reproduction test even in a complicated embedded system.

Furthermore, to prepare for automatically repeated reproduction tests, the present embodiment identifies a particular target event and records more detailed state variations of the individual functions when the target event is reproduced. This makes it possible to observe more detailed state variations of the individual functions which have been recorded previously when the target event is reproduced after the tests, thereby enabling more efficient fault analysis.

Moreover, to accelerate the reproduction in the repeated reproduction tests, the present embodiment carries out the time adjustment between the individual events or varies the intervals for each repetition, thereby achieving the reproducibility guidance. This enables an efficient test for ensuring the reliability of a complicated embedded system. In other words, even in such an event that will not appear in only a single reproduction because of a subtle timing error at collecting the logs or because of an error at the reproduction, since the reproduction test can be performed while restoring the repeated states, the accuracy of the reproducibility is improved.

Incidentally, by enabling handling the parameter settings such as of the events or intervals on an editable text basis, more flexible reproduction tests become possible such as increasing the number of times of repetition only for a part of an event group considered to improve the reproducibility, or deleting a part considered to have nothing to do with a particular event. This enables more efficient reproduction tests while reducing the load of a user.

### Embodiment 2

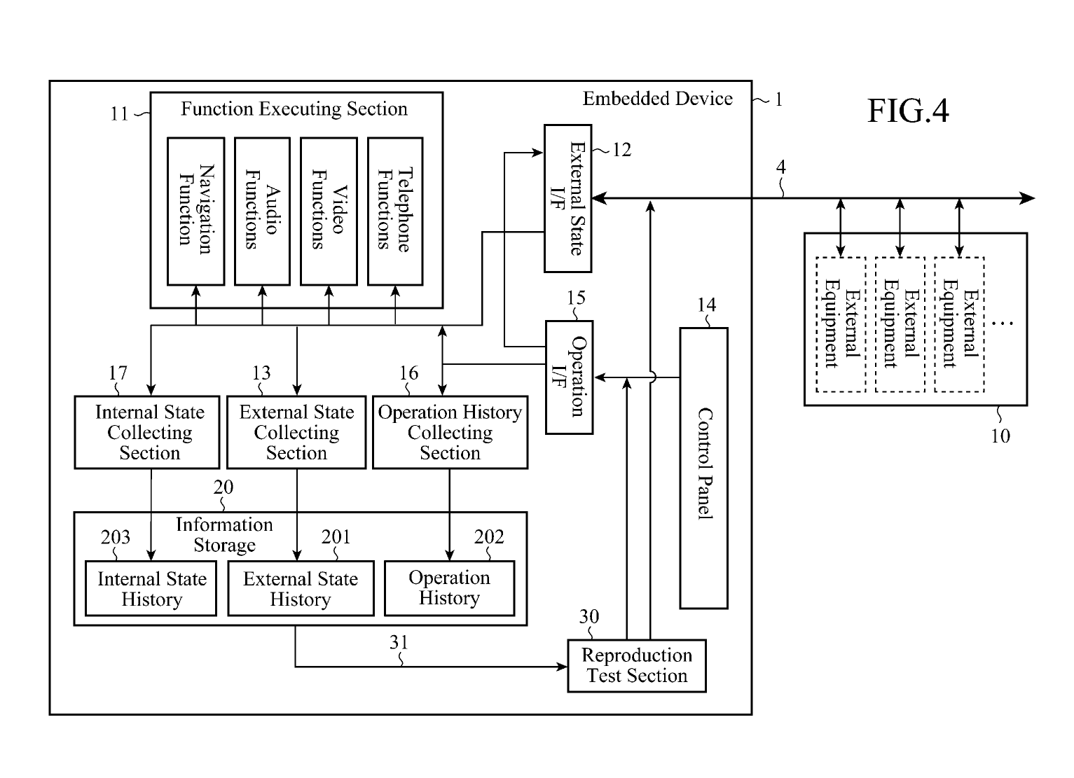

FIG. 4 is a block diagram showing an internal configuration of an automatic reproduction test device in an embedded system of an embodiment 2 in accordance with the present invention.

It differs from the embodiment 1 shown in FIG. 1 in that although the reproduction test device 2 is externally connected to the embedded system (onboard information equipment 1) in the embodiment 1, the functions of the reproduction test device 2 are incorporated into the embedded system in the present embodiment 2. The configuration enables the automatic reproduction test without preparing the reproduction test device 2 separately.

Thus, as shown in FIG. 4, a reproduction test section 30 is added to the onboard information equipment 1 serving as the embedded system. Since the reproduction test section 30 is directly connected to the information storage 20 via an internal bus 31, the storage medium 3 becomes unnecessary.

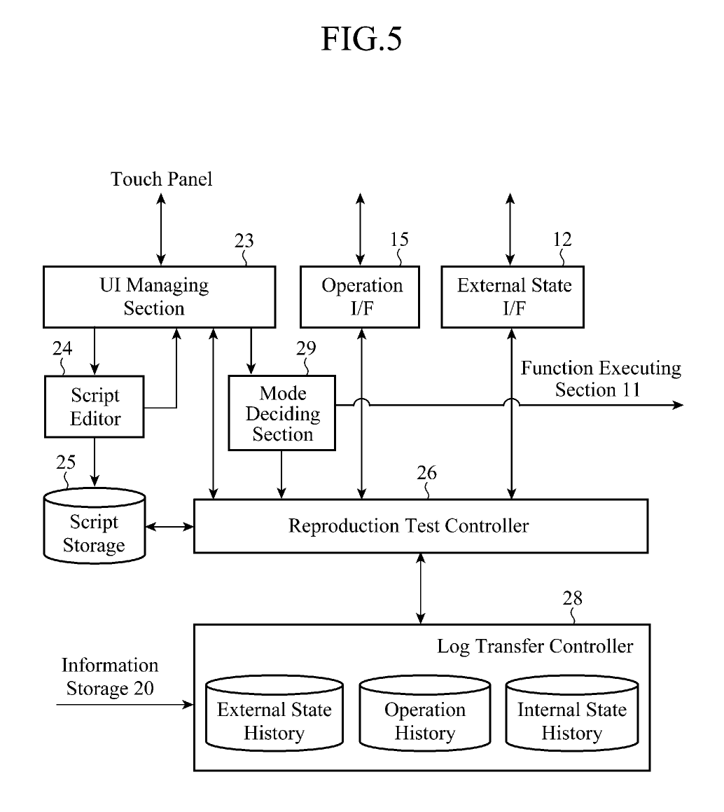

As for the reproduction test section 30, FIG. 5 shows its configuration with its functions developed. The difference in the configuration from that of the embodiment 1 shown in FIG. 2 is that a log transfer controller 28 and a mode deciding section 29 are added to the configuration of the reproduction test device 2 shown in FIG. 2. The log transfer controller 28 acquires the logs consisting of the external state history 201, operation history 202 and internal state history 203, which are stored in the information storage 20, and delivers them to the reproduction test controller 26 via the internal bus 31. The mode deciding section 29 makes a decision as to whether the onboard information equipment 1 is in an operating mode or in a reproduction test mode or not, and controls the log acquisition processing by the function executing section 11 or the automatic reproduction test processing by the reproduction test section 30.

Incidentally, since the functions of the reproduction test device 2 shown in FIG. 2 are incorporated into the onboard information equipment 1 serving as the embedded system, the operation interface 21 corresponds to the operation I/F 15 shown in FIG. 1, and the CAN bus interface 22 corresponds to the external state I/F 12 shown in FIG. 1. The remaining portion is the same as that of the embodiment 1 shown in FIG. 2.

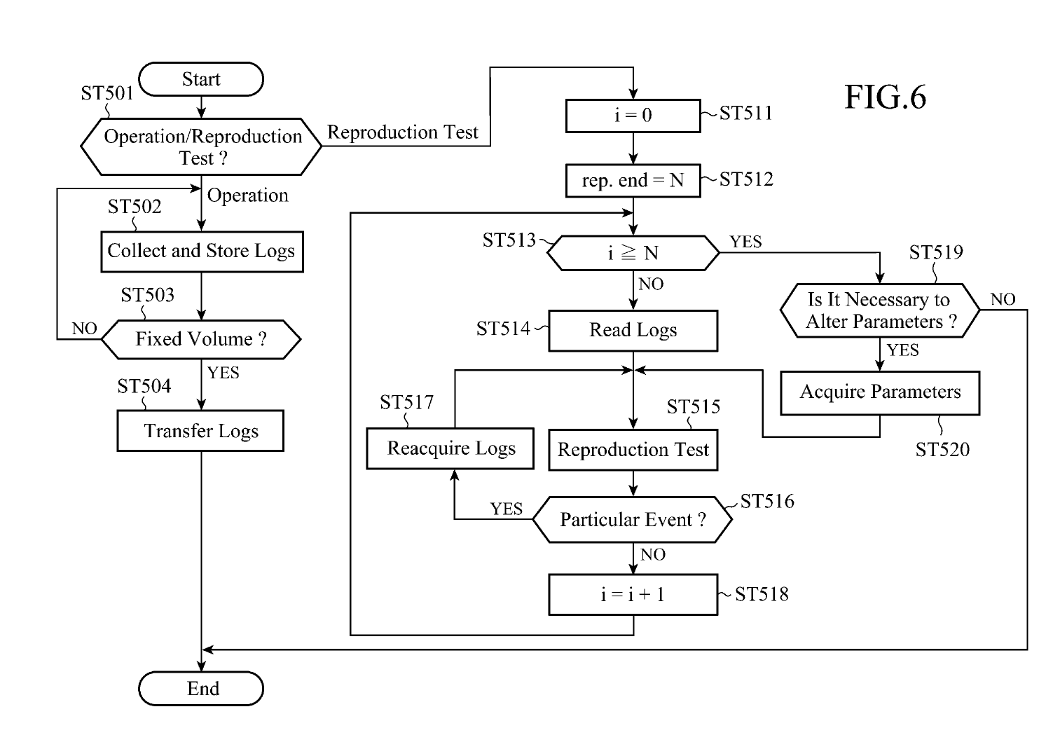

FIG. 6 is a flowchart showing the operation of the automatic reproduction test device in the embedded system of the embodiment 2 in accordance with the present invention.

Referring to the flowchart of FIG. 6, the operation of the automatic reproduction test device in the embedded system of the embodiment 2 in accordance with the present invention shown in FIG. 4 and FIG. 5 will be described in detail below.

In the flowchart of FIG. 6, according to the mode decision result of the mode deciding section 29, when the mode deciding section 29 indicates the operating mode (“operation” at step ST501), for example, the onboard information equipment 1 starts the log collecting processing by the external state collecting section 13, operation history collecting section 16 and internal state collecting section 17, respectively. The individual logs collected by the external state collecting section 13, operation history collecting section 16 and internal state collecting section 17 are stored in the areas of the external state history 201, operation history 202 and internal state history 203′ of the information storage 20 (step ST502).

Then, at the timing of storing a fixed volume (“YES” at step ST503), the information storage 20 transfers the logs to the reproduction test section 30 via the internal bus 31 (step ST504).

On the other hand, when the mode deciding section 29 indicates the reproduction test mode (“reproduction test” at step ST501), that is, when the reproduction test controller 26 detects the reproduction test start operation by the user via the UI managing section 23, it sets zero to the variable i (step ST511), followed by setting the number of times N of the repeated reproduction tests to the variable rep.end (step ST512).

Subsequently, the reproduction test controller 26 makes a decision as to whether the variable i reaches the number of times N of the repeated reproduction tests or not (step ST513). Unless it reaches (“NO” at step ST513), it reads the various logs arriving via the log transfer controller 28 (step ST514) and starts the reproduction test (step ST515). As described above, since the reproduction test is recorded as the logs about the state variations of the external equipment 10 and events in addition to the operation history, it is executed by restoring by reflecting them in the system state of the onboard information equipment 1 while synchronizing with the operation history.

Incidentally, during the foregoing reproduction test, if a particular event such as a fault is detected (“YES” at step ST516) the reproduction test controller 26 instructs the external equipment 10 and the control panel 14 to carry out the reacquisition instruction of the logs about the state variations just before via the external state I/F 12 and operation I/F 15 (step ST517). Here, according to the logs reacquired, the reproduction test is carried out again (step ST515).

When the reproduction test has been completed once as described above, the reproduction test controller 26 updates the variable i by adding +1 thereto (step ST518), and carries out reading of the logs and the reproduction test from step ST513 forward repeatedly (step ST513-ST518). The repeated reproduction tests are performed the number of times N repeatedly set at the variable rep.end.

Incidentally, when the N-times reproduction tests have been completed (“YES” at step ST513), the reproduction test controller 26 displays a message so stating on the input/output device via the UI managing section 23, and prompts the user to express his or her decision by displaying a message asking whether it is necessary to change the parameters or not. The foregoing reproduction test is carried out a fixed number of times at fixed repeated intervals. The reproduction test controller 26 acquires altered parameters (step ST520) which are input when the user makes a decision that the parameters must be altered (“YES” at step ST519), and executes the repeated reproduction tests again.

As described above, according to the automatic reproduction test device in the embedded system of the embodiment 2 in accordance with the present invention, it can carry out the automatic reproduction test without preparing the reproduction test device separately, and can remove the necessity for the external storage medium 3 like a memory card, thereby being able to make effective use of hardware resources the embedded system such as the onboard information equipment possesses.

In addition, in the same manner as the embodiment 1, the present embodiment 2 can improve the reproducibility of the repeated reproduction tests using the logs including the internal and external state histories besides the operation history, and can carry out the repeated reproduction tests flexibly by altering the number of times of repetitions and by adjusting parameters about the fluctuations in the time intervals of the individual events. In addition, by retaining the foregoing various logs in a text format to enable editing, the present embodiment can perform flexible reproduction test while reducing the load of the user.

Incidentally, as for the functions of the reproduction test device 2 or reproduction test section 30 of the foregoing embodiment 1 or embodiment 2, all of them can be implemented by software or at least part of them can be realized by hardware. For example, as for the data processing in which the reproduction test controller 26 reads out the contents stored in the history storage unit according to the external reproduction instruction, reproduces the internal state of the embedded system in accordance with the contents read out, and executes the reproduction tests of the embedded system a prescribed number of times repeatedly, it can be implemented by one or more programs on a computer, or at least part of it can be realized by hardware.

In addition, an automatic reproduction test method in the embedded system in accordance with the present invention is an automatic reproduction test method in the embedded system (onboard information equipment 1) which is used as the automatic reproduction test device including at least the history storage unit (information storage 20) and is connected to the external equipment 10 in FIG. 4, and has, in the flowchart of FIG. 6, for example, steps (ST501-ST504) of storing the operation events of the embedded system and the events including the state variations of the external equipment into the history storage unit in a time series, and steps (ST511-ST520) of reading out the contents stored in the history storage unit according to the external reproduction instruction, of reproducing the internal state of the embedded system in accordance with the contents read out, and of executing the reproduction test of the embedded system repeatedly a prescribed number of times.

As described above, according to the automatic reproduction test method in the embedded system in accordance with the present invention, it can achieve the efficient test for ensuring the reliability of the complicated embedded system.

Incidentally, according to the automatic reproduction test device and automatic reproduction test method in the embedded system in accordance with the present invention, at a fault modification, for example, they confirm modification contents by automatically carrying out the reproduction test according to the script, performs halation tests in all the cases according to the script modified so far, carries out remodification if halation occurs (if a particular fault causes another fault that does not relate directly to it), and performs the automatic reproduction test. In this case, according to the logs and the script stored, they obtain correlation between the modification pattern and the halation occurrence pattern by calculation (text comparison) by the automatic reproduction test, and decide test items based on the modification pattern by the extraction of the correlation, thereby being able to carry out the efficient automatic reproduction test within a limited period of time.

In addition, the automatic reproduction test device and automatic reproduction test method in the embedded system in accordance with the present invention have a wide variety of functions such as car navigation, audio, video, camera, telephone, and air conditioner functions, and can carry out efficient fault analysis and reproduction test in the embedded system like onboard information equipment with a complicated configuration with various external devices connected via a network. Thus, they enable efficient development and test of equipment in similar embedded systems, thereby contributing toward reduction of a developing period and improvement of the reliability of products.

### INDUSTRIAL APPLICABILITY

As described above, the present invention can perform efficient fault analysis and reproduction test, and is widely applicable to devices and embedded systems having a large variety of functions.

What is claimed is:

1. An automatic reproduction test device in an embedded system to which external equipment is connected, the automatic reproduction test device in the embedded system comprising:
a history storage unit for storing operation events of the embedded system and events including state variations of the external equipment in a time series; and
a reproduction test unit for reading out contents stored in the history storage unit in response to a reproduction instruction from outside, for reproducing a system state of the embedded system in accordance with the contents read out, and for carrying out a reproduction test of the embedded system a prescribed number of times repeatedly.

2. The automatic reproduction test device in the embedded system according to claim 1, wherein
the reproduction test unit carries out, on a basis of a result of the reproduction test, an adjustment of parameters including a number of times of repetition of the reproduction test in accordance with a request arriving via a user interface.

3. The automatic reproduction test device in the embedded system according to claim 1, wherein
the reproduction test unit, taking an opportunity of reproducing a particular event, gives the embedded system a reacquisition instruction of information about the state variations immediately before.

4. The automatic reproduction test device in the embedded system according to claim 1, wherein
the reproduction test unit converts a procedure defining the reproduction test into a text format and retains it, edits the procedure using a user interface, and carries out the reproduction test in accordance with the procedure edited.

5. The automatic reproduction test device in the embedded system according to claim 1, wherein
the contents stored in the history storage unit are transferred to an external storage medium connected to the embedded system, and are transferred to the reproduction test unit via the external storage medium.

6. The automatic reproduction test device in the embedded system according to claim 1, wherein
the contents stored in the history storage unit are transferred to the reproduction test unit via an internal bus of the embedded system.

7. An automatic reproduction test method of an embedded system which is used for an automatic reproduction test device having at least a history storage unit, and to which external equipment is connected, the automatic reproduction test method in the embedded system comprising:
a step of storing operation events of the embedded system and events including state variations of the external equipment in a time series; and
a step of reading out contents stored in the history storage unit in response to a reproduction instruction from outside, of reproducing a system state of the embedded system in accordance with the contents read out, and carrying out a reproduction test of the embedded system a prescribed number of times repeatedly.
